(19) United States
(12) Patent Application Publication
(10) Pub. No.: US 2005/0217107 A1
(43) Pub. Date: Oct. 6, 2005

(54) Core structure of stator transformer for rotary transformer

(75) Inventors: Mutsumi Matsuura, Omori-nishi (JP); Hiroyuki Naganuma, Hakusan-cho (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 11/146,156

(22) Filed: Jun. 7, 2005

Related U.S. Application Data
(62) Division of application No. 10/268,991, filed on Oct. 11, 2002.

(30) Foreign Application Priority Data
Oct. 12, 2001 (JP) 2001-315778

(51) Int. Cl. H01F 5/00

(52) U.S. Cl. 29/622

(57) ABSTRACT

A stator transformer is composed of a concave metal ring formed by drawing a metal plate produced by pressing, and a planer metal plate formed by pressing. The concave metal ring has a bottom having a through hole in which a rotor is to be disposed, and a side formed upstanding at the bottom. The side has a circular or elliptic guide hole for guiding a lead wire connected to a stator transformer coil to the outside. The metal plate has the through hole in which the rotor is to be disposed. The concave metal ring has therein the stator transformer coil wound around a bobbin. The metal plate and the end of the side of the concave metal ring, which is formed upstanding at the bottom, are integrated with each other by, for example, welding or force-fitting.

This is a Division of application Ser. No. 10/268,991 filed Oct. 11, 2002. The entire disclosure of the prior application is hereby incorporated by reference herein in its entirety

### BACKGROUND OF THE INVENTION

1. Field of the Invention

The present invention relates to a core structure of a stator transformer for a rotary transformer of a resolver or the like, and more particularly, to a core structure of a stator transformer suitable for a small-sized rotary transformer.

2. Description of the Related Art

This conventional type of stator transformer for a rotary transformer is used for input/output signals in a well-known resolver, synchro and the like, and is disclosed in, for example, Japanese Patent Application Publication No. 63-318725. A structure shown in FIG. 4 is adopted as the structure of the aforesaid stator transformer. Specifically, reference numeral 401 in FIG. 4 denotes a ring-shaped casing, in which a resolver section 402 and a rotary transformer 403 are provided. Also, a resolver stator 405 having a resolver stator coil 404 and a stator transformer 407 having a stator transformer coil 406 are arranged side by side on the casing 401 side.

Also, a rotary shaft (not shown) rotatably disposed in the casing 401 has a resolver rotor 411 having a resolver rotor coil 410 and a rotor transformer 413 having a rotor transformer coil 412, arranged side by side. The supply of current and the input/output of signals to the resolver section 402 are performed through the rotary transformer 403. The resolver stator 405, the stator transformer 407, the resolver rotor 411, and the rotor transformer 413 are all formed by cutting a solid iron rod. The stator transformer 407 is secured to the casing 401 side with a snap ring 460 formed of a C-ring.

The conventional rotary transformer thus configured gives problems hereinafter described. Since the stator transformer and the rotor transformer are manufactured by cutting the solid iron rod, material and processing costs have been both high, not suitable for mass production thereby posing many obstacles for the mass production and automated production of resolver and the like.

In order to solve the above problems, there is provided a stator transformer for a rotary transformer disclosed in, for example, Japanese Patent Application Publication No. 8-330160 shown in FIG. 5. A stator transformer 507 is composed of a pair of laminates 521 each having a plurality of annular metal plates 520 formed by pressing magnetic plates as shown in FIG. 5, and a metal band 522 provided between the laminates 521. The metal band 522 is formed by pressing into a spiral circle (with substantially two turns) having elasticity, and has a pair of pawls 522a on the side thereof. Also there is provided a guide hole 522b formed between the pawls 522a corresponding to the pawls 522a. The guide hole 522b guides a lead wire to the outside.

Each laminate 521 has a cut-out (not shown) formed on a rim thereof. Each pawl 522a of the metal band 522, which is disposed in a state in which it is sandwiched by the rims of the laminates 521, is brought into engagement with the cut-out, thereby locking the metal band 522 to each laminate 521. The stator transformer 507 composed of the laminates 521 and the metal band 522 is disposed in the same position as the stator transformer 407 in FIG. 4 and is secured to the casing 401 side with the snap ring 460 in a state in which a stator transformer coil 506 is provided inside the metal band 522 as shown in FIG. 5.

The conventional stator transformer shown in FIG. 5 includes the one pair of laminates formed by laminating a plurality of the annular metal plates and the metal band provided between the laminates instead of cutting the solid iron rod, in which all the laminates and the metal band are manufactured by pressing. However, such a stator transformer has the following problems. In a small-sized rotary transformer, the amount of current passing through the transformer, or a magnetic flux, is small, and accordingly, even a stator transformer made of a thin magnetic material does not become saturated. However, in the conventional example shown in FIG. 5, the one pair of laminates is formed by laminating a plurality of annular metal plates, and as a result, more material is used. Furthermore, the metal band is pressed into the spiral shape (with substantially two turns) having elasticity and has the one pair of pawls on the side thereof. Therefore, manufacturing thereof is time-consuming, and also it may be difficult to form a spiral metal band in a small-sized rotary transformer.

On the other hand, the stator transformer for the rotary transformer disclosed in Japanese Patent Application Publication No. 63-318725 is formed by cutting the solid iron rod. Accordingly, it is extremely difficult to cut it in a small-sized rotary transformer.

### SUMMARY OF THE INVENTION

It is an object of the present invention to provide a core structure of a rotary transformer suitable for a rotary transformer of a small-sized resolver or the like.

In a core structure of a stator transformer for a rotary transformer according to a first aspect of the present invention, a core structure of a stator transformer for a rotary transformer having a stator transformer coil and a guide hole for guiding a lead wire connected to the stator transformer coil to the outside includes a concave metal ring formed by drawing a sheet of metal plate produced by pressing, and a planer metal plate formed by pressing, wherein the metal plate has a through hole in which a rotor is to be disposed; the concave metal ring has a bottom having the through hole in which the rotor is to be disposed, and a side part formed in an upstanding condition at the bottom; the stator transformer coil is disposed inside the concave metal ring; and the end of the side of the concave metal ring and the metal plate are integrally formed.

In the core structure of the stator transformer for the rotary transformer according to a second aspect of the invention, preferably, the guide hole is formed on the side of the concave metal ring.

In the core structure of the stator transformer for the rotary transformer according to a third aspect of the invention, preferably, the guide hole is formed on the side of the concave metal ring, which is formed by drawing the one metal plate produced by pressing.

In the core structure of the stator transformer for the rotary transformer according to a fourth aspect of the invention, preferably, the concave metal ring is made of a magnetic material having a property of being able to be drawn according to the thickness of the concave metal ring.

### BRIEF DESCRIPTION OF THE DRAWINGS

FIGS. 1A to 1C show a core structure of a stator transformer for a rotary transformer according to an embodiment of the present invention, wherein FIG. 1A is an front view thereof, FIG. 1B is a cross-sectional view taken along line B-B in FIG. 1A, and FIG. 1C is a top view seen from the direction of the arrow A in FIG. 1A.

FIGS. 2A to 2C are explanatory views of a concave metal ring, wherein FIG. 2A shows the concave metal ring before processing, FIG. 2B shows the concave metal ring after processing, and FIG. 2C is a top view of FIG. 2B seen from the direction of the arrow A.

FIGS. 3A and 3B are explanatory views of a metal plate, wherein FIG. 3A is an front view thereof and FIG. 3B is a cross-sectional view taken along line C-C in FIG. 3A.

FIG. 4 is a cross-sectional view of a conventional rotary transformer.

FIG. 5 is a cross-sectional view of the conventional stator transformer for a rotary transformer.

### DESCRIPTION OF THE PREFERRED EMBODIMENTS

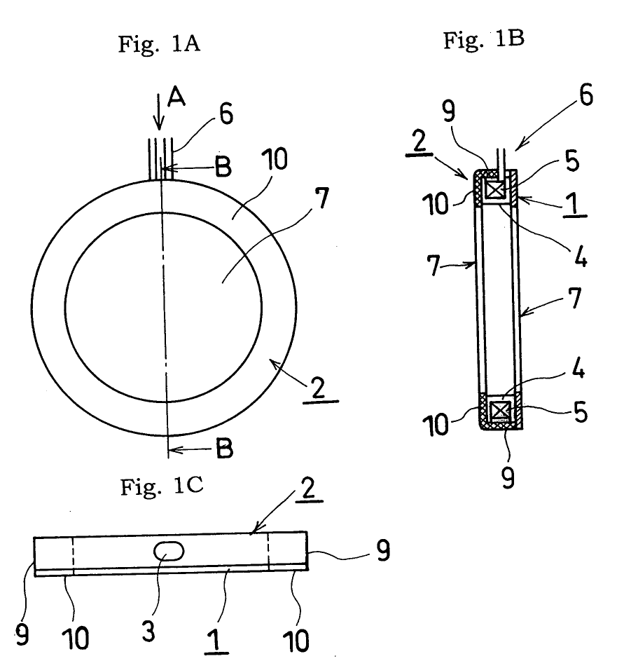

FIGS. 1A to 1C show a core structure of a stator transformer for a rotary transformer according to an embodiment of the present invention, wherein FIG. 1A is an front view thereof, FIG. 1B is a cross-sectional view taken along line B-B in FIG. 1A, and FIG. 1C is a top view seen from the direction of the arrow A in FIG. 1A. An embodiment of the stator transformer for a rotary transformer of a resolver or the like according to the present invention will be specifically described hereinbelow with reference to the drawings. Since the structure of the resolver is identical to that of the conventional example, only a stator transformer different from the conventional one will be described.

A stator transformer shown in FIG. 1 is formed of a concave metal ring 2 formed by drawing a sheet of metal plate produced by pressing and a planer metal plate 1 processed by pressing. The concave metal ring 2 includes a bottom 10 having a through hole 7 in which a rotor (not shown) is to be disposed, and a side part 9 formed in the upright condition at the bottom 10. The side part 9 has a guide hole 3 for guiding a lead wire 6 connected to a stator transformer coil 5 to the outside formed in a circular or elliptic shape. The metal plate 1 has the through hole 7 formed therein, in which the rotor (not shown) is to be disposed.

The concave metal ring 2 has therein the stator transformer coil 5 wound around a bobbin 4. The stator transformer coil 5 wound around the bobbin 4 is secured in the inside of the concave metal ring 2 with an adhesive, a molding material or the like. The metal plate 1 and the end of the side part 9 formed in the upright condition at the bottom of the concave metal ring 2 are integrated with each other by, for example, welding or force-fitting such that the through hole 7 of the metal plate 1 and the through hole 7 of the concave metal ring 2 are concentric.

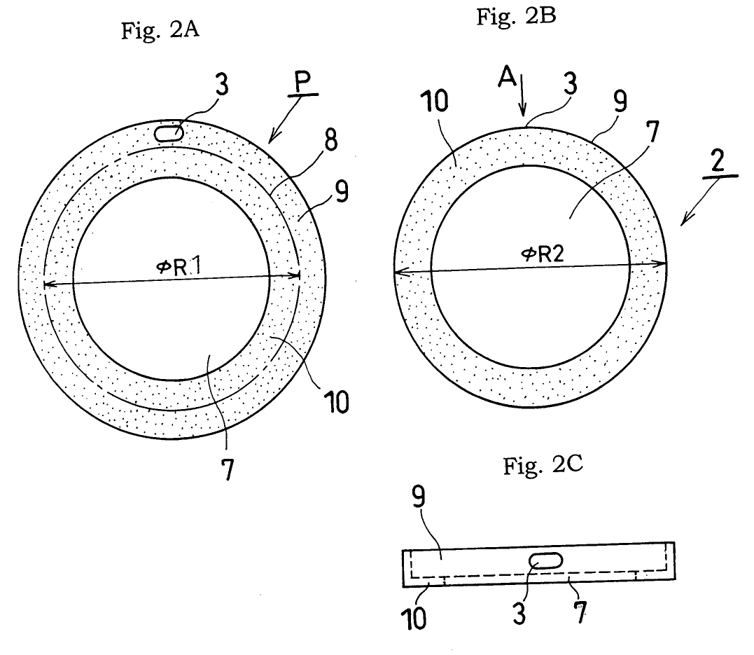

FIGS. 2A to 2C are explanatory views of the concave metal ring 2, wherein FIG. 2A shows the concave metal ring 2 before processing, FIG. 2B shows the concave metal ring 2 after processing, and FIG. 2C is a top view of FIG. 2B seen from the direction of the arrow A. The concave metal ring 2 is manufactured as follows. First, a planar metal plate made of a magnetic material is stamped out by a well-known method to form a circular plate P having the through hole 7, in which the rotor is to be disposed at the center thereof, and the circular or elliptic guide hole 3 for guiding the lead wire 6 to the outside as shown in FIG. 2A. The circular plate P is made of a magnetic material which has a drawing property according to the thickness of the concave metal ring, such as a nickel-iron alloy (Permalloy), an iron-cobalt alloy, and a silicon steel.

The outer dimension of the circular plate P in FIG. 2A is determined in consideration of the plate thickness so as to match the outer dimension of the concave metal ring 2. Next, a diameter portion 8 indicated by alternate long and short dashed lines is drawn by a well-known method to form the concave metal ring 2 as shown in FIG. 2B. The diameter ΦR1 of the portion 8 indicated by the alternate long and short dashed lines is substantially identical to the outside diameter ΦR2 of the concave metal ring 2. The concave metal ring 2, subject to drawing as described above, includes the bottom 10 having the through hole 7 in which the rotor is to be disposed, and the side part 9 formed in the upright condition thereon, and the side part 9 has the guide hole 3 formed therein.

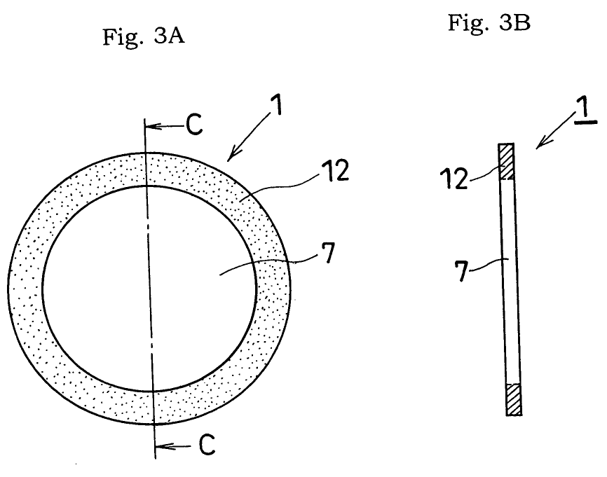

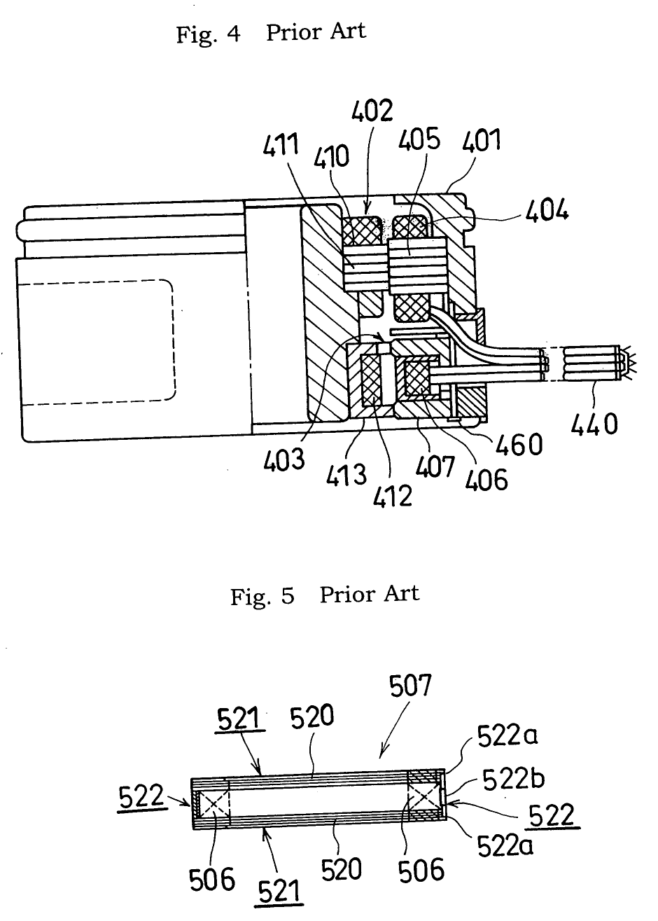

FIGS. 3A and 3B are explanatory views of the metal plate 1, wherein FIG. 3A is an front view thereof and FIG. 3B is a cross-sectional view taken along line C-C in FIG. 3A. The metal plate 1 is made of the same magnetic material as the concave metal ring 2, the outer diameter of the metal plate 1 is equal to that of the concave metal ring 2 subject to drawing, and inner of which the through hole 7 having the rotor disposed therein is formed. The metal plate 1 is produced in a manner similar to the method of stamping out the circular plate P. The stator transformer coil 5 wound around the bobbin 4 is disposed inside the concave metal ring 2, and the metal plate 1 and the concave metal ring 2 are integrated by, for example, welding such that the through hole 7 of the metal plate 1 and the through hole 7 of the concave metal ring 2 are concentric thereby forming the stator transformer for the rotary transformer as described in FIG. 1.

Although the guide hole 3 for guiding the lead wire 6 to the outside is circular or elliptic in the embodiment of the invention, it may be of other shapes, for example, a cut-out formed in the direction of the metal plate 1. In such a case, the guide hole 3 is formed when the concave metal ring 2 is integrated with the metal plate 1.

The core structure of the rotary transformer according to the first aspect of the invention includes the concave metal ring formed by drawing a sheet of metal plate produced by pressing and the one planer metal plate formed by pressing, wherein the stator transformer coil is disposed inside the concave metal ring, and the concave metal ring and the metal plate are integrated with each other. Consequently, a core suitable for the rotary transformer of a small-sized resolver or the like can be provided at low cost.

In the core structure of the rotary transformer according to the second aspect of the invention, the guide hole is formed on the side of the concave metal ring. Accordingly, the lead wire can easily be guided to the outside.

In the core structure of the rotary transformer according to the third aspect of the invention, the guide hole is formed before the concave metal ring is subject to drawing. Consequently, the guide hole can be formed without the influence of drawing.

In the core structure of the rotary transformer according to the fourth aspect of the invention, the concave metal ring is made of a magnetic material having the property of being drawn according to the thickness of the concave metal ring. Consequently, the concave metal ring can be easily drawn depending on the size of the core of the rotary transformer.

1. A method of forming a core structure of a stator transformer having a stator transformer coil and a guide hole for guiding a lead wire connected to the stator transformer coil to the outside, comprising:
pressing a planar plate comprising a magnetic material having a thickness and a drawing property determined by the thickness to form a circular plate, said circular plate having a through hole in the center thereof in which a rotor is to be disposed and a guide hole for guiding a lead wire connected to the stator transformer coil to the outside; and
drawing a diameter portion of the circular plate to form a concave metal ring having a bottom and an outside diameter, the bottom having:
a diameter substantially identical to the outside diameter of the concave metal ring; and
a through hole in the center thereof and a side part formed in the upright condition thereof, such that the guide hole is disposed on said side part.

2. The method of claim 1, further comprising disposing a stator transformer coil inside the concave metal ring.

3. The method of claim 1, further comprising integrating the concave metal ring and the circular plate.

4. The method of claim 3, wherein the concave metal ring and the circular plate are integrated by welding.

5. The method of claim 3, wherein the concave metal ring and the circular plate are integrated by force-fitting.

6. The method of claim 2, wherein the guide hole is formed when the concave metal ring is integrated with the circular plate.

7. The method of claim 1, wherein the guide hole is formed before the concave metal ring is formed.

8. The method of claim 1, wherein the metal plate comprises one of a nickel-iron alloy, an iron-cobalt alloy and a silicon steel.
